(19) United States
(12) Patent Application Publication
(10) Pub. No.: US 2024/0359281 A1
(43) Pub. Date: Oct. 31, 2024

(54) AUTOMATED TOOLPACK AND TOOLING CHANGER FOR A BODYMAKER

(71) Applicant: Stolle Machinery Company, LLC, Centennial, CO (US)

(72) Inventor: Joseph John Allen Maurer, Aurora, CO (US)

(73) Assignee: Stolle Machinery Company, LLC, Centennial, CO (US)

(21) Appl. No.: 18/645,986

(22) Filed: Apr. 25, 2024

Related U.S. Application Data
(60) Provisional application No. 63/462,399, filed on Apr. 27, 2023.

(51) Int. Cl. B23Q 3/157; B21D 51/26

(52) U.S. Cl. CPC B23Q 3/15713; B21D 51/2669

(57) ABSTRACT

A system for manufacturing a plurality of can bodies includes a number of forming machines for forming one or more portions of the can bodies. Each forming machine includes a number of removable components. The system further includes a maintenance device including a housing, a changeout arrangement coupled to the housing, and a controller positioned on or in the housing. The changeout arrangement is configured to selectively remove and replace a removeable component of one or more of the number of removeable components of one or more of the number of forming machines under the direction and control of the controller.

### CROSS REFERENCE TO RELATED APPLICATIONS

This application claims priority to U.S. Provisional Patent Application Ser. No. 63/462,399, filed Apr. 27, 2023, titled “Automated Toolpack and Tooling Changer For A Bodymaker.”

### FIELD OF THE INVENTION

The disclosed concept relates generally to systems for use in producing can bodies and more particularly to automated arrangements for use in such systems.

### BACKGROUND OF THE INVENTION

Different types of cans are manufactured for various purposes such as containers for food and beverages. The amount of cans that are produced each year by a single factory is immense. In a can production factory, efficiency is a significant concern. Downtime in a production line or less than optimal operation reduces the amount of cans produced by a factory. Given the amount of cans produced by a can production line, even small reductions in efficiency can have a significant impact of the quantity of cans produced by the can production line.

The tooling in a can bodymaker needs to be frequently replaced or removed in order to clear a can jam. This process entails stopping the machine, opening the guard door, and pulling out the toolpack modules to access the tooling. The modules are generally large and heavy, some weighing over 30 lbs. This process is repeated many times throughout the day which is exhausting and poses a risk to the operator(s) due to having to manually lift the tool pack modules out of the machine which requires the operator to be bent over with arms extended outwards. Additionally, it is common for the operator to improperly torque a punch bolt, place a die backwards, or install a die in the wrong carrier which leads to poor can quality and damaged equipment and tooling. Hence, there is room for improvement in can bodymakers as well as other machines used in forming can bodies.

### SUMMARY OF THE INVENTION

These needs, and others, are met by aspects of the disclosed concept. As a first aspect of the disclosed concept, a system for manufacturing a plurality of can bodies is provided. The system comprises: a number of forming machines, each forming machine structured to form a portion of each can body of the plurality of can bodies, each forming machine comprising a number of removable components; and a maintenance device comprising: a housing, a changeout arrangement coupled to the housing; and a controller positioned on or in the housing, wherein the changeout arrangement is structured to selectively remove and replace a removeable component of one or more of the number of removeable components of one or more of the number of forming machines under the direction and control of the controller.

The maintenance arrangement may further comprise a mobilization arrangement coupled to the housing, the mobilization arrangement being structured to move the housing with respect to at least one forming machine of the number of forming machines under the direction and control of the controller.

The mobilization arrangement may comprise an aerial arrangement positioned above the number of forming machines, wherein the aerial arrangement is structured to move the housing and changeout arrangement with respect to the at least one forming machine of the number of forming machines without contacting a floor adjacent or among the number of forming machines. The aerial arrangement may comprise a track and a number of motorized followers coupled between the track and the housing, wherein the number of motorized followers are structured to move the housing along the track.

The mobilization arrangement may comprise a number of ground engaging motorized drive arrangements for moving the housing with respect to the number of forming machines. The plurality of ground engaging motorized drive arrangements may comprise a number of wheels and/or a number of tread arrangements.

The changeout arrangement may comprise a robotic arm.

The number of forming machines may comprise a plurality of forming machines and the mobilization arrangement may be structured to move the housing among the plurality of forming machines.

The number of forming machines may comprise a can bodymaker and the number of removeable components may comprise one or more of a toolpack and/or a punch.

The housing may be structured to house one or more of the removeable components and/or replacements for one or more of the removeable components.

The changeout arrangement may be structured to select a replacement for one of the removeable components from a storage area, and the maintenance device may be structured to transport the replacement for one of the removable components to a forming machine of the number of forming machines.

As another aspect of the disclosed concept, a maintenance device such as previously described is provided.

These and other objects, features, and characteristics of the disclosed concept, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are provided for the purpose of illustration and description only and are not intended as a definition of the limits of the concept.

### BRIEF DESCRIPTION OF THE DRAWINGS

A full understanding of the invention can be gained from the following description of the preferred embodiments when read in conjunction with the accompanying drawings in which:

FIG. 1 is a schematic diagram of a system for producing a plurality of can bodies in accordance with an example embodiment of the disclosed concept;

FIG. 2 is a schematic diagram of a maintenance device in accordance with an example embodiment of the disclosed concept for use in a system such as shown in FIG. 1;

FIG. 3 is a partially schematic view of a maintenance device in accordance with an example embodiment of the disclosed concept shown positioned adjacent a portion of a can bodymaker;

FIG. 4 is a partially schematic representation of a maintenance device in accordance with another example embodiment of the disclosed concept; and

FIG. 5 is a partially schematic representation of a maintenance device in accordance with yet another example embodiment of the disclosed concept.

### DETAILED DESCRIPTION OF THE INVENTION

It is to be appreciated that the specific elements illustrated in the drawings and described herein are simply exemplary embodiments of the disclosed concept intended to convey the general concept(s) provided herein. Accordingly, specific dimensions, orientations and other physical characteristics related to the embodiments disclosed herein are not to be considered limiting on the scope of the disclosed concept.

As employed herein, the term “can” refers to any known or suitable container, which is structured to contain a substance (e.g., without limitation, liquid, food, any other suitable substance), and expressly includes, but is not limited to, beverage cans, such as beer and soda cans, as well as cans used for food.

As used herein, “coupled” means a link between two or more elements, whether direct or indirect, so long as a link occurs. An object resting on another object held in place only by gravity is not “coupled” to the lower object unless the upper object is otherwise maintained substantially in place. That is, for example, a book on a table is not coupled thereto, but a book glued to a table is coupled thereto.

As used herein, “directly coupled” means that two elements are coupled in direct contact with each other.

As used herein, “fixedly coupled” or “fixed” means that two components are coupled so as to move as one while maintaining a constant orientation relative to each other. The fixed components may, or may not, be directly coupled.

Directional phrases used herein, such as, for example, left, right, front, back, top, bottom and derivatives thereof, relate to the orientation of the elements shown in the drawings and are not limiting upon the claims unless expressly recited therein.

As employed herein, the term “number” shall mean one or an integer greater than one (i.e., a plurality).

As employed herein, the term “controller” shall mean an electronic control arrangement that can store, retrieve, and process data as well as provide outputs to control other elements. Hence, a “controller” as used herein may include one or more of a microprocessor; a microcontroller; a microcomputer; a central processing unit; or any suitable processing/control device or apparatus.

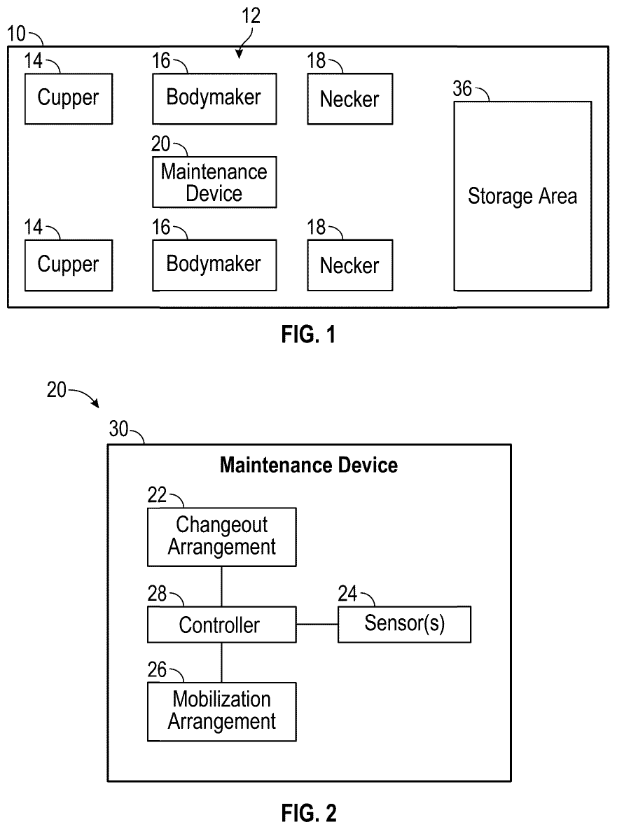

Referring to FIG. 1, a schematic diagram of a system 10 for producing a plurality of can bodies in accordance with an example embodiment of the disclosed concept is shown. System 10 includes a number of forming machines 12, each forming machine being structured to form a portion of each can body of the plurality of can bodies. An example can production facility in which system 10 is employed would typically include one or more can production lines with machines typically named near to their function, e.g., without limitation, cuppers, bodymakers, washers, coat ovens, base coaters, decorators, internal spray machines, neckers, light testers, and palletizers. The can production line(s) may include other machines and intermediary machinery such as conveyance machinery. In the example embodiment shown in FIG. 1, forming machines 12 include: cuppers 14, bodymakers 16, and neckers 18. It is to be appreciated, however, that such example forming machines are provided for exemplary purposes only and that embodiments of system 10 may include other machines and/or exclude some of the machines shown in FIG. 1 without varying from the scope of the disclosed concept. Each forming machine 12 includes a number of removable components (e.g., one or more of: housing components, dies, strippers, rams, bearings, etc.) that commonly need moved, removed and/or replaced for inspection and/or maintenance purposes.

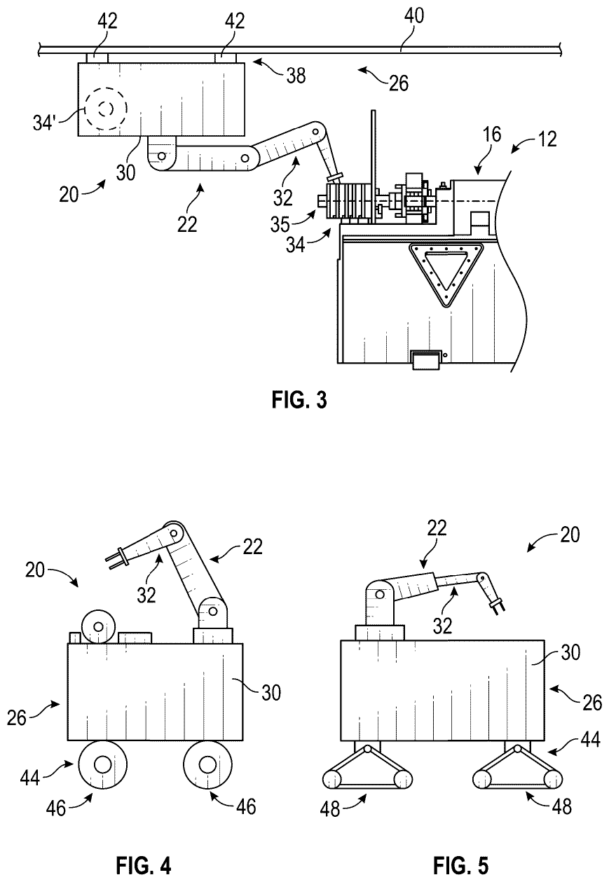

Continuing to refer to FIG. 1, system 10 further includes a maintenance device 20. As shown schematically in FIG. 2, in one example embodiment maintenance device 20 includes: a changeout arrangement 22, a number of sensors 24, a mobilization arrangement 26, a controller 28 in communication with all of the aforementioned components, and a frame/housing 30 to which the aforementioned elements of maintenance device 20 are coupled via any suitable means. Changeout arrangement 22 may be any suitable selectively actuatable arrangement (e.g., a robotic arm 32—see FIGS. 3-5, or any suitable arrangement(s)) and is structured to selectively remove and replace a removeable component of one or more of the number of removeable components of one or more of the number of forming machines 12 under the direction and control of controller 28 utilizing feedback from one or more of the number of sensor(s) 24. For example, the example embodiment illustrated in FIG. 3 shows changeout arrangement 22 in the form of robotic arm 32 engaging a toolpack 34 of bodymaker 16. The robotic arm 32 is sized and configured to remove and replace toolpack 34 as well as any related components of bodymaker 16 (e.g., a punch 35, cover panels, cupper arrangements, etc.) needed for maintenance or other purposes. The robotic arm 32 is also sized and configured to replace toolpack 34 with a replacement toolpack 34′, which may be carried by maintenance device 20 (such as shown in FIG. 3) on or within housing 30 and/or which may be otherwise stored local to the bodymaker 16. The number of sensor(s) 24 may be a quantity (i.e., one or more) of any suitable devices/arrangements that is/are positioned as needed for a particular application for determining positioning of maintenance device 20 and/or objects about maintenance device 20 for guiding maintenance device 20 among forming machines 12 and/or other objects; and/or for determining position/guiding changeout arrangement 22 about maintenance device 20 or about any object (e.g., one of forming machines 12).

Mobilization arrangement 26 is structured to move housing 30, and thus changeout arrangement 22, with respect to the number of forming machines 12 under the direction and control of controller 28 or any other suitably situated processing device. Further, mobilization arrangement 26 may be structured to move housing 30 and related items to/from a storage area 36 (FIG. 1) wherein tooling, spare parts, and/or maintenance device 20 itself may be housed/stored when not in use. In an example embodiment of the disclosed concept, changeout arrangement 22 is structured to select one or more replacements for one or more of the removeable components from storage area 36 and to transport the replacement to one or more of the forming machines 12 (and subsequently install the replacement part(s)).

Mobilization arrangement 26 may be generally any suitable arrangement for moving/transporting changeout arrangement 22 and related items/parts (discussed below) among one or more of forming machines 12 and/or among one or more forming machines 12 and another location (e.g., storage area 36) under the direction/control of controller 28 (or other suitable situated processing device) without varying from the scope of the disclosed concept. For example, FIG. 3 shows an example embodiment in which mobilization arrangement 26 is an aerial arrangement 38 positioned above the number of forming machines (e.g., bodymaker 16). Aerial arrangement 38 is structured to move the housing 30 and changeout arrangement 22 with respect to at least one forming machine of the number of forming machines 12 without contacting a floor adjacent or among the number of forming machines 12. In such example embodiment, aerial arrangement 38 includes a track 40 (e.g., coupled to overhead members of a structure enclosing system 10) and a number of motorized followers 42 coupled between housing 30 and the track 40 that are structured to move maintenance device 20 along track 40 under the direction and control of controller 28.

FIGS. 4 and 5 show some other examples of maintenance devices 20 in accordance with example embodiments of the disclosed concept in which mobilization arrangement 26 includes a plurality of ground engaging motorized drive arrangements 44 for moving maintenance device 20 with respect to the number of forming machines 12 along the floor (not numbered) about and among the forming machines 12. More particularly, FIG. 4 shows an example in which ground engaging motorized drive arrangements 44 are in the form of wheels 46, whereas FIG. 5 shows an example in which ground engaging motorized drive arrangements 44 are in the form of motorized tread-arrangements 48 (e.g., similar to a tank, snowmobile, skid-steer, etc.).

From the foregoing, it is thus to be appreciated that the disclosed concept provides solutions for inspecting/maintaining forming machines 12 that require little to no human involvement. Instead, a machine-controlled maintenance device/changeout arrangement can identify a part needing replaced, remove the part, replace the part, and move on to other machines.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

What is claimed is:

1. A system for manufacturing a plurality of can bodies, the system comprising:
a number of forming machines, each forming machine structured to form a portion of each can body of the plurality of can bodies, each forming machine comprising a number of removable components; and
a maintenance device comprising:
a housing;
a changeout arrangement coupled to the housing; and
a controller positioned on or in the housing,
wherein the changeout arrangement is structured to selectively remove and replace a removeable component of one or more of the number of removeable components of one or more of the number of forming machines under the direction and control of the controller.

2. The system of claim 1, wherein the maintenance device further comprises a mobilization arrangement coupled to the housing, the mobilization arrangement being structured to move the housing with respect to at least one forming machine of the number of forming machines under the direction and control of the controller.

3. The system of claim 2, wherein the mobilization arrangement comprises an aerial arrangement positioned above the number of forming machines, and wherein the aerial arrangement is structured to move the housing and changeout arrangement with respect to the at least one forming machine of the number of forming machines without contacting a floor adjacent or among the number of forming machines.

4. The system of claim 3, wherein the aerial arrangement comprises a track and a number of motorized followers coupled between the track and the housing, wherein the number of motorized followers are structured to move the housing along the track.

5. The system of claim 2, wherein the mobilization arrangement comprises a number of ground engaging motorized drive arrangements for moving the housing with respect to the number of forming machines.

6. The system of claim 5, wherein the plurality of ground engaging motorized drive arrangements comprises a number of wheels and/or a number of tread arrangements.

7. The system of claim 1, wherein the changeout arrangement comprises a robotic arm.

8. The system of claim 2, wherein the number of forming machines comprises a plurality of forming machines and wherein the mobilization arrangement is structured to move the housing among the plurality of forming machines.

9. The system of claim 1 wherein the number of forming machines comprises a can bodymaker and wherein the number of removeable components comprises one or more of a toolpack and/or a punch.

10. The system of claim 2, wherein the housing is structured to house one or more of the removeable components and/or replacements for one or more of the removeable components.

11. The system of claim 2, wherein:
the changeout arrangement is structured to select a replacement for one of the removeable components from a storage area, and the maintenance device is structured to transport the replacement for one of the removable components to a forming machine of the number of forming machines.

12. A maintenance device for use in a system for producing a plurality of can bodies, the system including a number of forming machines, each forming machine structured to form a portion of each can body of the plurality of can bodies, each forming machine comprising a number of removable components, the maintenance device comprising:
a housing;
a changeout arrangement coupled to the housing; and
a controller positioned on or in the housing,
wherein the changeout arrangement is structured to selectively remove and replace a removeable component of one or more of the number of removeable components of one or more of the number of forming machines under the direction and control of the controller.

13. The maintenance device of claim 12, further comprising a mobilization arrangement coupled to the housing, the mobilization arrangement being structured to move the housing with respect to at least one forming machine of the number of forming machines under the direction and control of the controller.

14. The maintenance device of claim 13, wherein the mobilization arrangement comprises an aerial arrangement positioned above the number of forming machines, and wherein the aerial arrangement is structured to move the housing and changeout arrangement with respect to the at least one forming machine of the number of forming machines without contacting a floor adjacent or among the number of forming machines.

15. The maintenance device of claim 14, wherein the aerial arrangement comprises a track and a number of motorized followers coupled between the track and the housing, wherein the number of motorized followers are structured to move the housing along the track.

16. The maintenance device of claim 13, wherein the mobilization arrangement comprises a number of ground engaging motorized drive arrangements for moving the housing with respect to the number of forming machines.

17. The maintenance device of claim 16, wherein the plurality of ground engaging motorized drive arrangements comprises a number of wheels and/or a number of tread arrangements.

18. The maintenance device of claim 12, wherein the changeout arrangement comprises a robotic arm.

19. The maintenance device of claim 13, wherein the housing is structured to house one or more of the removeable components and/or replacements for one or more of the removeable components.

20. The maintenance device of claim 13, wherein:
the changeout arrangement is structured to select a replacement for one of the removeable components from a storage area, and the maintenance device is structured to transport the replacement for one of the removable components to a forming machine of the number of forming machines.
